(19) United States
(12) Patent Application Publication
(10) Pub. No.: US 2010/0117471 A1
(43) Pub. Date: May 13, 2010

(54) MICRO VIBRATION MOTOR WITH ADJUSTABLE VIBRATION AMOUNT

(75) Inventor: Chiang-Cheng Huang, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: RISUN EXPANSE CORP., Taipei (TW)

(21) Appl. No.: 12/613,831

(22) Filed: Nov. 6, 2009

(30) Foreign Application Priority Data
Nov. 7, 2008 (TW) 097220054

(51) Int. Cl. H02K 7/06

(52) U.S. Cl. 310/81

(57) ABSTRACT

A micro vibration motor with adjustable vibration amount includes a rotor and a stator. The rotor includes a round cover; a perforation, formed on a rotation center of the round cover; a weight portion, integrally formed on an edge of the round cover, for changing a mass center of the round cover, in which the weight portion has at least one slot formed thereon; and at least one movable part, selectively disposed in each slot, for changing a weight of the weight portion, so as to adjust a vibration amount generated during the rotation of the round cover according to design demands.

### CROSS-REFERENCE TO RELATED APPLICATIONS

This non-provisional application claims priority under 35 U.S.C. §119(a) on Patent Application No(s). 097220054 filed in Taiwan, R.O.C. on Nov. 7, 2008, the entire contents of which are hereby incorporated by reference.

### BACKGROUND OF THE INVENTION

1. Field of the Invention

The present invention relates to a micro motor, and more particularly to a micro vibration motor with adjustable vibration amount.

2. Related Art

Recently, micro vibration motors have been widely applied in people's life with the advent of digital era and aging of population. The most notable application is in the mobile phone. When a call is coming, the mobile phone generally has two types of modes to alert users, one is the ring tone mode, and the other is the mute vibration mode. When a mobile phone is set to the vibration mode, the micro vibration motor must be used to generate the vibration. The micro vibration motor is also used in other digital mobile devices, entertaining game players, and handheld game players. Along with the fierce competition in the industry of producing entertaining devices, providing merely video and audio effects can no longer satisfy changeful tastes of consumers, and thus some manufacturers have provided consumers with touch stimulation in the entertaining devices. For example, the Immersion Co. of the US has a number of patents that use touch technology on computer peripherals, such as a vibration mouse, a vibration keyboard, and a vibration joy stick on game player. In order to implement the touch mechanisms, the vibration can also be generated by the vibration motor.

In response to the demands of market, the design concept of short, small, light, and thin has become a current trend. The size of the micro vibration motor disposed in a light and thin mobile phone must be reduced accordingly. However, the reduced volume of the motor results in the increased cost due to that the parts having the reduced sizes are not easily assembled. Further, an offset of a rotor cannot be too large due to the limit of the size, such that a vibration amount of the micro vibration motor cannot be increased, and the user quite easily neglects the vibration alert of the incoming call of the mobile phone if being not quite careful.

In terms of means of generating vibration amount, U.S. Pat. No. 6,836,039 discloses a technique that comprises an annular magnet with six planar poles. A weight object is added to one side so that the rotor has a gravity center eccentric to its rotation center, so as to generate the vibration. However, the design increases the load of the rotor, so more input electric energy is needed. Moreover, adding the weight object makes the volume of the motor higher, and thus it is difficult to miniaturize the motor. U.S. Pat. No. 6,573,627 discloses a technique that comprises an annular magnet with four planar poles located eccentrically on a rotor disk. When the rotor disk rotates, the eccentric gravity center of the rotor causes vibration. However, due to space limit, the eccentricity between the annular magnet and the rotation center is limited. As a result, the increasing of the vibration amount is limited.

### SUMMARY OF THE INVENTION

In the above patents, the conventional micro vibration motors still have complicated structures, and the complexity of windings of induction coils is disadvantageous to the production of the micro vibration motors and the demands of miniaturization or microminiaturization. Therefore, the present invention is a micro vibration motor with adjustable vibration amount, in which the vibration amount of the micro vibration motor is changed through a structural design capable of adjusting weight, so as to perform an optimal and maximum adjusting application in a limited space, thereby satisfying various design demands.

The present invention provides a motor with adjustable vibration amount, which comprises a rotor and a stator, and the rotator rotates on the stator. The rotor comprises a round cover; a perforation, formed on a rotation center of the round cover; a weight portion, integrally formed on an edge of the round cover, for changing a mass center of the round cover, in which the weight portion has at least one slot formed thereon; and at least one movable part, selectively disposed in each slot, for changing a weight of the weight portion, so as to adjust a vibration amount generated during the rotation of the round cover.

In the micro vibration motor with adjustable vibration amount, a weight structure capable of performing a fine tuning is designed on the rotor, and is selectively combined with the movable part, such that most flexible adjustment may be made according to practical product design demands, thereby performing the optimal and maximum adjusting application in the limited space. In addition, the present invention adopts an integrally formed structure, so as to have advantages such as a high strength, a small number of parts, a simple structure, a simple assembly, and a low cost, thus becoming an optimal design of the micro vibration motor.

### BRIEF DESCRIPTION OF THE DRAWINGS

The present invention will become more fully understood from the detailed description given herein below for illustration only, and thus are not limitative of the present invention, and wherein:

FIG. 1 is a schematic cross-sectional structural view of a micro vibration motor with adjustable vibration amount according to the present invention;

FIG. 2 is a schematic structural view of a rotor of the micro vibration motor with adjustable vibration amount according to the present invention;

FIG. 3 is a top view of the rotor of the micro vibration motor with adjustable vibration amount according to the present invention;

FIG. 4 is a cross-sectional view of the rotor of the micro vibration motor with adjustable vibration amount according to the present invention;

FIG. 5 is a schematic structural view of a stator of the micro vibration motor with adjustable vibration amount according to the present invention;

FIG. 6 is a top view of the stator of the micro vibration motor with adjustable vibration amount according to the present invention;

FIG. 7 is a cross-sectional view of the stator of the micro vibration motor with adjustable vibration amount according to the present invention; and

FIG. 8 is a top view of a rotor of a micro vibration motor with adjustable vibration amount according to another embodiment of the present invention.

### DETAILED DESCRIPTION OF THE INVENTION

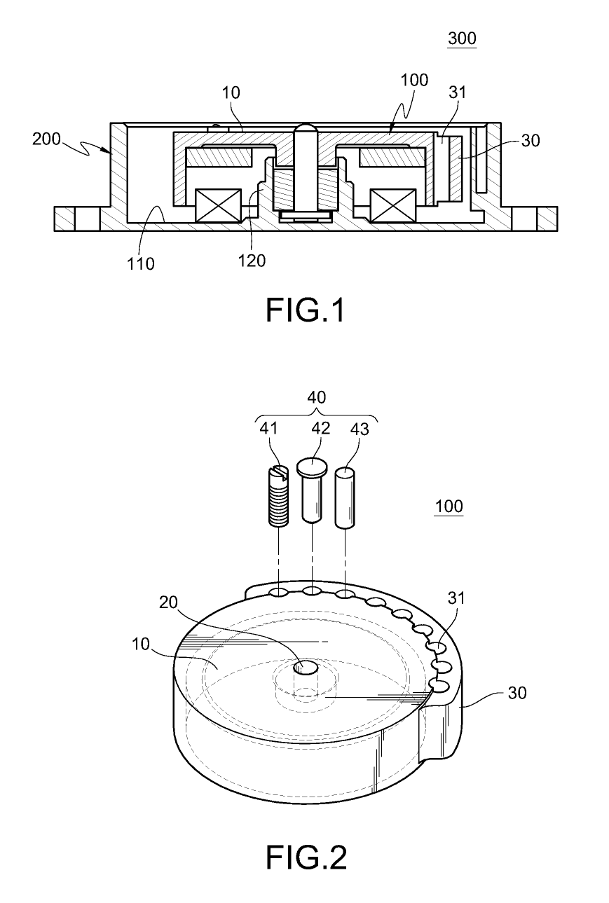

FIG. 1 is a schematic cross-sectional structural view of a micro vibration motor with adjustable vibration amount according to the present invention. Referring to FIG. 1, the micro vibration motor 300 according to the present invention comprises a rotor 100 and a stator 200, in which the rotor 100 rotates on the stator 200. An induction coil, a magnetic element, and a spindle in FIG. 1 are not key points of the present invention, and a detailed structure of the micro vibration motor 300 (such as the induction coil, the magnetic element, and a circuit board) may be obtained with reference to US Publication Patent No. 20020195890, so it is not described in detail in the following.

FIG. 2 is a schematic structural view of the rotor of the micro vibration motor with adjustable vibration amount according to the present invention. Next, referring to FIG. 2, the rotor 100 according to the present invention comprises a round cover 10, a perforation 20, a weight portion 30, and a movable part 40.

The round cover 10 is mainly made of a magnetic material (metal material such as iron, cobalt, and nickel).

The perforation 20 is formed on a rotation center of the round cover 10. The perforation 20 enables the rotor 100 to sleeve on a spindle (not shown) coaxially.

The weight portion 30 is integrally formed on an edge of the round cover 10, for changing a mass center of the round cover 10. The weight portion 30 has nine slots 31 formed thereon (the number of the slots 31 may be increased or reduced and positions of the slots 31 may be adjusted according to design demands). The relative slots 31 punched on the weight portion 30 may be in a shape of round, square, triangle, and other random geometrical shapes corresponding to a shape of the movable part 40.

The movable part 40 may be selectively disposed in each slot 31, for changing a weight of the weight portion 30, so as to adjust the vibration amount generated during rotation of the round cover 10. With a current mechanical manufacturing technology, in the procedure of manufacturing the rotor 110, a plurality of relative slots 31 is punched on the weight portion 30, so as to form the detachable movable part 40 on the weight portion 30, such that it is quite easy in manufacturing. Alternatively, the movable part 40 is manufactured in an additional processing manner, and the movable part 40 may be, for example, a countersunk head screw 41, a nail 42, a cotter 43, or a latch. When the movable part 40 is the countersunk head screw 41, the slots 31 need to have screw threads.

When it intends to increase the vibration amount, one or more movable parts 40 may be selectively disposed in the slots 31 of the weight portion 30, so as to increase the weight of the weight portion 30, in this manner, an entire gravity center is further eccentric to the rotation center, so as to further increase the vibration amount generated during the rotation of the round cover 10. When it intends to reduce the vibration amount, one or more movable parts 40 may be selectively removed from the slots 31 of the weight portion 30, so as to reduce the weight of the weight portion, in this manner, the vibration amount generated during the rotation of the round cover 10 is reduced. Therefore, according to the design of the present invention, the vibration amount may be adjusted depending on the practical application product demands.

Therefore, the micro vibration motor 300 according to the present invention may be applied to various electronic products (for example, a personal digital assistant (PDA), a mobile phone, or a global positioning system (GPS) etc.). Under a design trend of short, small, light, and thin, in the present invention, through the rotor 100 structure capable of fine-tuning the vibration amount, the vibration amount of the micro vibration motor 300 may be increased in a limited space, which fully satisfies the diversified design demands of various electronic products.

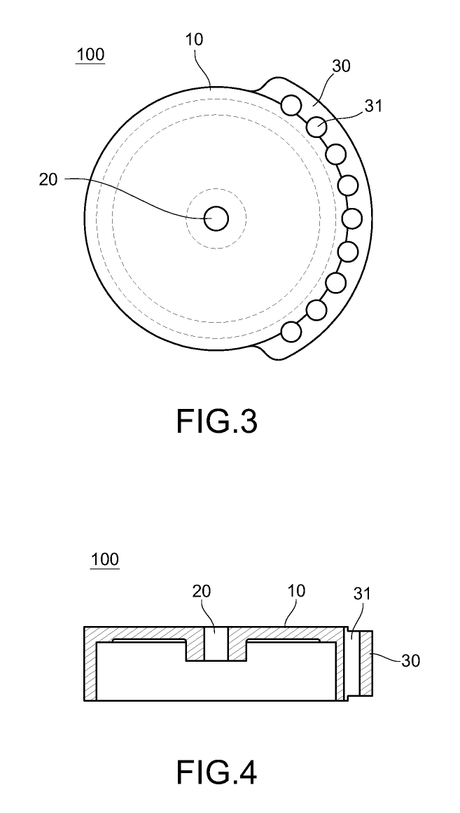

FIG. 3 is a top view of the rotor of the micro vibration motor with adjustable vibration amount according to the present invention. Referring to FIG. 3, the weight portion 30 in the rotor 100 according to the present invention is schematically in a shape of a bracket “)”. The weight portion 30 is used to change the mass center of the round cover 10, such that the rotor 100 generates the vibration when rotating.

FIG. 4 is a cross-sectional view of the rotor of the micro vibration motor with adjustable vibration amount according to the present invention. Referring to FIG. 4, the weight portion 30 according to the present invention is integrally formed on the edge of the round cover 10, such that it is quite easy in manufacturing, thus having advantages such as an easy manufacturing, a high strength, a small number of parts, a simple structure, a simple assembly, and a low cost.

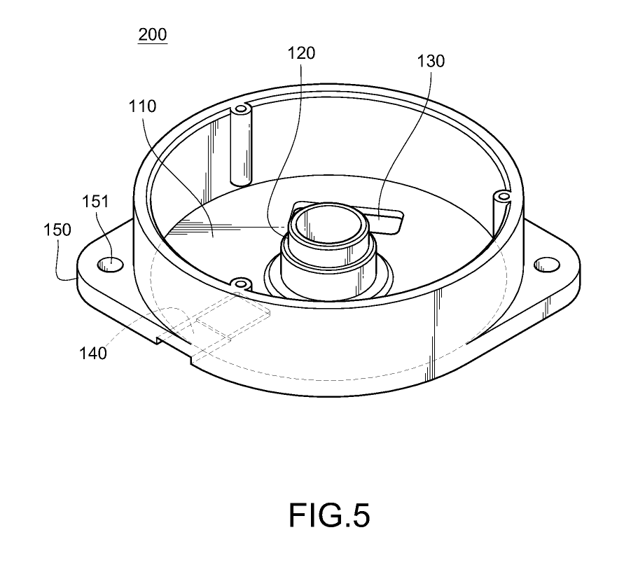

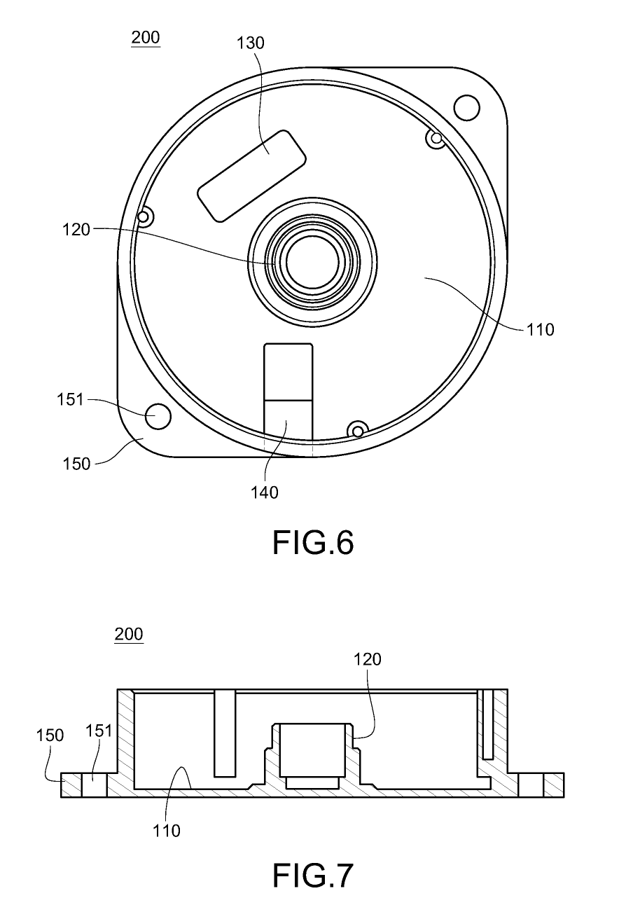

FIG. 5 is a schematic structural view of the stator of the micro vibration motor with adjustable vibration amount according to the present invention. Referring to FIG. 5, the stator 200 according to the present invention comprises a spindle seat 120, a first long hole 130, a second long hole 140, and a fixing portion 150.

The stator 200 is schematically a round disc structure, and an inner diameter of the round cover 10 of the rotor 100 is smaller than an inner diameter of the round disc structure of the stator 200. The first long hole 130 and the second long hole 140 are opened on a bottom surface 110 of the stator 200. A perforation 151 is formed in the fixing portion 150. The stator 200 is fixed in various electronic products (not shown) through the perforation 151 on the fixing portion 150 together with a fixing part (not shown).

FIG. 6 is a top view of the stator of the micro vibration motor with adjustable vibration amount according to the present invention. Referring to FIG. 6, the first long hole 130 in the stator 200 according to the present invention is a wholly hollow structure, and the second long hole 140 is a partially hollow structure. Referring to FIG. 7, a cross-sectional view of the stator of the micro vibration motor with adjustable vibration amount according to the present invention is shown.

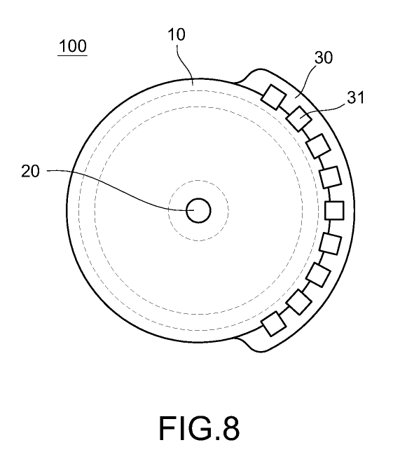

FIG. 8 is a top view of a rotor of a micro vibration motor with adjustable vibration amount according to another embodiment of the present invention. Referring to FIG. 8, slots 31 in a weight portion 30 according to another embodiment of the present invention are rectangular.

To sum up, in the micro vibration motor with adjustable vibration amount according to the present invention, the weight structure capable of performing a fine tuning is designed on the rotor, and is selectively combined with the movable part, such that the most flexible adjustment may be made according to practical product design demands, thereby performing the optimal and maximum adjusting application in the limited space. In addition, the present invention adopts an integrally formed structure characteristic, so as to have advantages such as a high strength, a small number of parts, a simple structure, a simple assembly, and a low cost, thus becoming an optimal design of the micro vibration motor.

What is claimed is:

1. A micro vibration motor with adjustable vibration amount, comprising a stator and a rotor rotating on the stator, wherein the rotor comprises:
a round cover;
a perforation, formed on a rotation center of the round cover;
a weight portion, integrally formed on an edge of the round cover, for changing a mass center of the round cover, wherein the weight portion has at least one slot formed thereon; and
at least one movable part, selectively disposed in the slots, for changing a weight of the weight portion, so as to adjust a vibration amount generated during rotation of the round cover.

2. The micro vibration motor with adjustable vibration amount according to claim 1, wherein the movable part is in a random geometrical shape, and the slot corresponds to the shape of the movable part.

3. The micro vibration motor with adjustable vibration amount according to claim 1, wherein the movable part is a latch.

4. The micro vibration motor with adjustable vibration amount according to claim 1, wherein the movable part is a countersunk head screw.

5. The micro vibration motor with adjustable vibration amount according to claim 1, wherein the movable part is a nail.

6. The micro vibration motor with adjustable vibration amount according to claim 1, wherein the movable part is a cotter.
